(19) United States
(12) Patent Application Publication
(10) Pub. No.: US 2007/0241661 A1
(43) Pub. Date: Oct. 18, 2007

(54) High light output lamps having a phosphor embedded glass/ceramic layer

(76) Inventor: Chua Bee Yin, Perak (MY)

Correspondence Address: Kathy Manke;Avago Technologies Limited, 4380 Ziegler Road, Fort Collins, CO, 80525, US

(21) Appl. No.: 11/402,667

(22) Filed: Apr. 12, 2006

(51) Int. Cl. H01J 1/62

(52) U.S. Cl. 313/502

(57) ABSTRACT

A lamp having a glass/ceramic composite having phosphor embedded therein is disclosed for use with high power light sources. In one embodiment, the phosphor is embedded in a thin film as quantum dots. In one embodiment, a glass shell surrounds the light source and the composite phosphor matrix to protect the lamp from outside environmental conditions.

### TECHNICAL FIELD

This invention relates to high light output lamps and move particularly to such lamps that use wavelength changing materials to generate specific colors.

### BACKGROUND OF THE INVENTION

As light-emitting devices become more widely used it is inevitable that they will be desired for use under increasingly more severe circumstances and conditions and under increased power and light output. For example, in applications for aircraft or automotive vehicles, the light-emitting devices are used as high as +80° C. or more, or as low as −20° C. or less. Such devices are subjected to outside air pressure, thermal shocks, as well as vibrations. Under such conditions, thermal stress causes each component to repeatedly expand and contract thereby compromising their structural integrity. Compounding the problem is that newly developed light-emitting elements, which can emit light in the near-ultraviolet range with high-luminosity, are now available. It would be desirable to include such light-emitting elements in high power lamps. However, to do so, it is important to reduce deterioration of the elements. This is especially true for the luminescent material used in these lamps which is subject to break down due to environmental reasons.

Presently, resin with a siloxane-coupling is receiving attention as a light support material (encapsulant) because it does not deteriorate by the light passing through the resin. This is so since the resin is impervious to the light in the range of 350-800 nm. Actually, the siloxane works best to block light in the UV/blue range of 350-480 nm, but it also helps in the higher range as well. The siloxane is also resistant to heat from the light source. While this resin also has high flexibility, its surface is soft and thus its mechanical strength is low. Therefore, such resins are not suitable to use as an exterior member of a light-emitting device. Further, the siloxane surface is tacky allowing foreign particles to adhere thereto. Another problem with such resins is their reduction in light output over the light output of previous epoxy encapsulants.

Epoxy encapsulants, even though they have better light output compared to silicone, (reflective index of epoxy=1.5 compared to silicone=1.3), are not suitable for high power as the epoxy material does not withstand high temperature and because the epoxy breaks down under UV light.

### BRIEF SUMMARY OF THE INVENTION

A lamp having a glass/ceramic composite having phosphor embedded therein is disclosed for use with high power light sources. In one embodiment, the phosphor is embedded in a thin film as quantum dots. In one embodiment, a glass shell surrounds the light source and the composite phosphor matrix to protect the lamp from outside environmental conditions.

### BRIEF DESCRIPTION OF THE DRAWINGS

FIG. 1 shows one embodiment of a lamp in accordance with the invention;

FIG. 2 shows one embodiment of a process for construction, the lamp of FIG. 1; and

FIG. 3 shows one embodiment of constructing a phosphor embedded substrate.

### DETAILED DESCRIPTION OF THE INVENTION

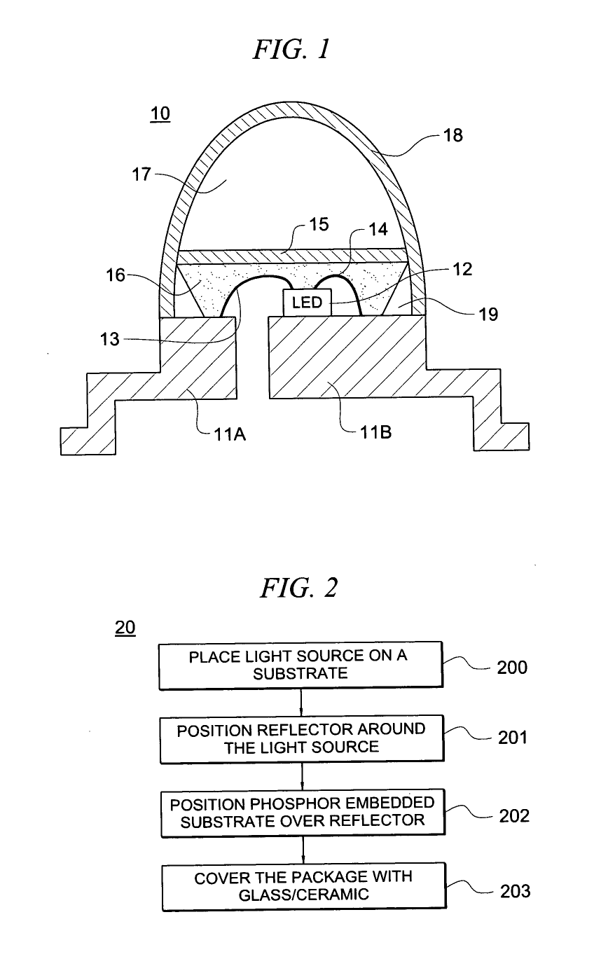

FIG. 1 shows one embodiment of a lamp in accordance with one invention in which lamp 10 has base structure elements 11A and 11B. The light source, in this embodiment an LED, such as LED 12, is mounted to base element 11B, which element together with element 11A is metallic in order to act as a heat transfer path to move heat away from the light source. Light source 12 is controlled by wires 13 and 14 bonded to the respective base elements. The light source is within (optimal) reflector cup 19 which can, if desired, be made from reflective glass and/or metal.

Optical gel 16 surrounds light source 12, and layer 15 is positioned above the optical gel. Layer 15 is, in the embodiment shown, a glass/ceramic matrix with phosphor embedded therein. In one embodiment the phosphor is constructed as a thin film and is quantum dot phosphor.

Surrounding layer 15 is, in one embodiment, air gap 17. Shell 18 surrounds the device. In this embodiment, shell 18 is glass and provides protection from external environmental conditions as well as high transparency to light. The glass can be, for example, a glass/ceramic mixture. This is the same type of glass that is used to cover high temperature devices, such as, heating elements.

The phosphor within layer 15 serves to change the wavelength of the light emitted from light source 12. The construction, as discussed hereinafter, of layer 15, is such as to withstand heat from the light source as well as to protect the phosphor from UV and other wavelength energy.

Glass/ceramic material can be coated around the phosphor particles to protect against degradation of the phosphor when the phosphor is exposed to moisture or temperature cycling and to enable the phosphor to withstand the heat within the lamp package. The phosphor can also be embedded as a ‘thin-film’ like a very thin piece of glass and be placed on top of diode.

The distance between the light source and layer 15 is not critical. In one embodiment, when using flip chip technology, the siloxane can sit slightly above the diode. As for those diodes with wire bonds, the distance would be greater than or equal to 0.1 mm above the wire.

The most common luminescent materials used for wavelength shifting in light devices (especially in LED devices) that produce broad-spectrum color light are fluorescent particles made of phosphors, such as Garnet-based phosphors, Silicate-based phosphors, Orthosilicate-based phosphors, Sulfide-based phosphors, Thiogallate-based phosphors and Nitride-based phosphors. The luminescent material used in glass/ceramic layer 15 is not limited to these materials.

In a preferred embodiment quantum dots, also known as semiconductor nanocrystals, can be used for wavelength shifting. These quantum dots are artificially fabricated devices that confine electrons and holes. Typical dimensions of quantum dots range from nanometers to few microns. Quantum dots have a photo luminescent property to absorb light and reemit different wavelength light, similar to phosphor particles. In most situations, the color characteristics of emitted light from quantum dots depend on the size of the quantum dots, rather than their chemical composition. However, there are some quantum dots which allow for color tuning by changing the chemical composition.

Quantum dots are characterized by a bandgap smaller than the energy of at least a portion of the light emitted from the light source, e.g., from LED die 12. The quantum dots included in the wavelength-shifting region may be quantum dots made of CdS, CdSe, CdTe, CdPo, ZnS, ZnSe, ZnTe, ZnPo, MgS, MgSe, MgTe, PbSe, PbS, PbTe, HgS, HgSe, HgTe and Cd(Si₁₋ₓSeₓ), or made from a metal oxides group, which consists of BaTiC>3, PbZrO₃, PbZr_{z}Tij._{z}O₃, BaₓSri.ₓ TiO₃, SrTiO₃, LaMnO₃, CaMnO₃, Lai_{—}_{^{x}}CaₓMnO₃. The quantum dots may further be coated with a material having an affinity for the host matrix. The coating passivates the quantum dots to prevent agglomeration or aggregation to overcome the van der Waals binding force between the quantum dots.

The coating on the quantum dots can be, for example, organic caps, shells, or caps made of glass material. Organic caps can be formed on quantum dots using Ag₂S and Cd(OH)₂, which may preferably be passivated with Cd²⁺ at high pH. A surface modification of the quantum dots is then performed by attaching dyes to the surface of the quantum dots. As an example, CdSe surface surfactant is labile and can be replaced by sequential addition of Se⁺ and Cd²⁺, which can grow to make a seed (quantum dot) larger. For Cd²⁺ rich surface, the surface can be treated with Ph-Se and an organic coating is covalently linked to the surface. This isolation of molecular particles is referred to as “capped”. One type of known capped molecules include Michelle liquids (Fendler), Tio-terminations (S-based) (Weller-Hamburg), Phosphate termination (Berwandi-MTT), Nitrogen termination (pyridine, pyrazine) and Dendron caps (multi-stranded ligands) (Peng).

Shells are coatings on the inner core material of the quantum dots. Generally, coating material that forms the shells can be oxide or sulfide based. Examples of shell/core are TiO₂/Cds, ZnO/CdSe, ZnS/Cds and SnO₂/CdSe. CdSe cores can also be coated with ZnS, ZnSe (selenide based) or CdS, which improves the efficiency of the CdSe.

Caps made of glass material are used for embedding the quantum dots. The glass material is normally Si nanocrystals in glass and organic matrixes (e.g., epoxy and silicon). Layer 15 (which could in some situations be multiple layers) can be coated (as discussed above) in a glass/ceramic matrix. Advanced ceramics has high appeal in this application due to a combination of properties, such as wear resistance, hardness, stiffness and corrosion resistance. In addition, ceramics has relatively high mechanical strength at high temperatures.

Low temperature ceramic materials used in the lamps must densify below 900° C., and in the sintered state must exhibit a coefficient of thermal expansion (CTE) which is close to silicon. These requirements are fulfilled by the use of glass/ceramic composites. The glass must form a low viscosity melt at low temperature (<900° C.) to achieve liquid phase sintering. The ceramic filler that is used to support the phosphor is selected to optimize thermal, transmission and other properties. The filler material should exhibit a similar CTE to the glass with which they are mixed and should also have a limited solubility in the glass. Relevant filler materials such as Al2O3, SiO2 and mullite or mixtures of them can be used as a diffusant material so that the light that is produced is homogenous. These types of glass/ceramic materials can be obtained from Nippon Electric Glass Co., Ltd. (NEG) located in Shiga, Japan.

In one embodiment, the glass/ceramic material is coated around the phosphor at the end of the phosphor manufacturing process when glass/ceramic material is in semi-liquid state at around 400-600° C.

FIG. 2 shows another embodiment 20 in which a thin piece of glass/ceramic is constructed with phosphor embedded therein by having the glass/ceramic material in a semi-solid state. In process 200, a light source, such as LED 12 (FIG. 1), is placed on a substrate, for example, on substrate 11A, 11B. Reflector cup 19 (if needed) is placed around the light source. A phosphor embedded substrate, such as substrate 15, is positioned over reflector cup 19 by process 205 perhaps by using a pick and place machine. If a reflector is not used, then a support is used (not shown in FIG. 1) to hold the substrate above the light source. The entire package is then surrounded in process 206 by glass/ceramic cover 18.

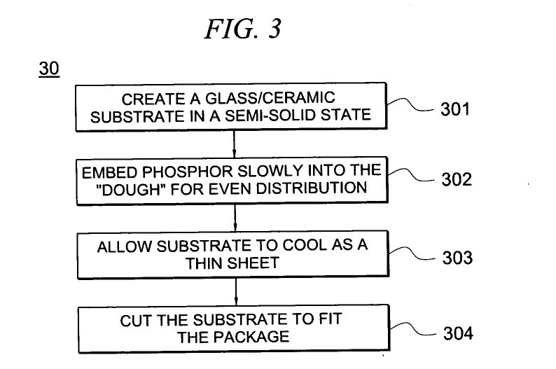

FIG. 3 shows one embodiment 30 for constructing a phosphor embedded substrate. In process 301, there is created a glass/ceramic substrate in a semi-solid state.

In process 302, phosphor is added to the semi-solid glass/ceramic substrate taking care not to have the temperature of the glass/ceramic be too high (preferably it should be below 700° C.) when incorporating the phosphor as this can damage the phosphor material. At this stage the glass/ceramic material has a ‘dough’ type of texture and the phosphor can be introduced into this dough slowly to ensure that the phosphor is evenly distributed in the matrix. Once done, this will be formed in process 303 as a thin piece of glass. The thin piece of glass can then be cut, process 304, to fit the packaging size.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A light device comprising:
a light source;
phosphor embedded glass/ceramic layer positioned over said light source; and
a light transparent outer shell positioned over said phosphor layer and separated therefrom.

2. The light device of claim 1 wherein said separation is an air gap.

3. The device of claim 2 wherein said outer-shell is glass.

4. The device of claim 3 wherein said embedded layer is thin-film.

5. The device of claim 4 wherein said embedded phosphor comprises:
quantum dots.

6. The device of claim 5 further comprising:
optical gel surrounding said light source between said light source and said layer.

7. The device of claim 1 wherein said light source is mounted on a base.

8. The device of claim 7 wherein said base is metallic.

9. A light device comprising:
a support structure;
a light source mounted to said support structure;
an optical gel surrounding said light source;
a phosphor glass/ceramic matrix positioned above said optical gel; and
a light-transparent cover surrounding said light source, said optical gel and said matrix.

10. The device of claim 9 wherein said light source is a LED chip.

11. The device of claim 10 wherein said phosphor in said matrix operates to change the wavelength light emitted by said LED chip.

12. The device of claim 10 further comprising:
an air gap between said matrix and said cover.

13. The device of claim 12 wherein said cover is glass.

14. A method for constructing a lamp, said method comprises:
attaching a light source to a support;
positioning a phosphorus glass/ceramic layer above said attached light source; and
encasing said positioned layer and said attached light source within a hard light-transparent structure.

15. The method of claim 14 wherein said light-transparent structure is glass/ceramic.

16. The method of claim 15 wherein said glass/ceramic is a dome.

17. The method of claim 15 wherein said support conducts heat.

18. The method of constructing a lamp, said method comprising:
placing a light source on a substrate;
positioning a support around said placed light source; and
positioning a phosphor embedded substrate on said support such that said phosphor embedded substrate is held away from said light source.

19. The method of claim 18 further comprising:
covering said light source and said phosphor embedded substrate with a glass/ceramic cover.

20. The method of claim 19 wherein said support is a reflector.
